(19) United States
(12) Patent Application Publication
(10) Pub. No.: US 2017/0034480 A1
(43) Pub. Date: Feb. 2, 2017

(54) COMMUNICATION DEVICE, COMMUNICATION SYSTEM, AND COMPUTER-READABLE RECORDING MEDIUM

(71) Applicants: Tomoyuki GOTO, Kanagawa (JP); Koji KUWATA, Kanagawa (JP); Hiroaki UCHIYAMA, Kanagawa (JP); Kiyoto IGARASHI, Kanagawa (JP); Kazuki KITAZAWA, Kanagawa (JP); Nobumasa GINGAWA, Kanagawa (JP); Masato TAKAHASHI, Tokyo (JP)

(72) Inventors: Tomoyuki GOTO, Kanagawa (JP); Koji KUWATA, Kanagawa (JP); Hiroaki UCHIYAMA, Kanagawa (JP); Kiyoto IGARASHI, Kanagawa (JP); Kazuki KITAZAWA, Kanagawa (JP); Nobumasa GINGAWA, Kanagawa (JP); Masato TAKAHASHI, Tokyo (JP)

(21) Appl. No.: 15/214,977

(22) Filed: Jul. 20, 2016

(30) Foreign Application Priority Data
Jul. 28, 2015 (JP) 2015-149044

(51) Int. Cl. H04N 7/15; G10L 25/78; G06T 7/00; H04N 7/14

(52) U.S. Cl. CPC H04N 7/15; H04N 7/147; G10L 25/78; G06T 7/004

(57) ABSTRACT

A communication device includes: a voice input unit configured to input voice that occurs in a site in which the communication device is installed; an imaging unit configured to capture an image of an inside of the site; a recording unit configured to, when speech is made in the site, record a speech spot indicating a location of a speaker and a time in a storage unit; a range determining unit configured to, when a plurality of the speech spots in the site are recorded within a predetermined time, determine a shooting range including the recorded speech spots; and a transmitting unit configured to transmit video of the determined shooting range to other communication device installed in other site.

### CROSS-REFERENCE TO RELATED APPLICATIONS

The present application claims priority under 35 U.S.C. §119 to Japanese Patent Application No. 2015-149044, filed Jul. 28, 2015. The contents of which are incorporated herein by reference in their entirety.

### BACKGROUND OF THE INVENTION

1. Field of the Invention

The present invention relates to communication devices, communication systems, and computer-readable recording media.

2. Description of the Related Art

A teleconference system has been in widespread use as one of communication systems that realize communication between users by using a communication network, such as the Internet. The teleconference system performs data communication between communication devices in a plurality of sites connected to a communication network and outputs video and voice collected by a camera and a microphone in a certain site from a display device and a speaker in the other sites, thereby implementing a remote conference between geographically remote sites.

As a function of a communication device, for example, there is known a technology of performing beamforming of a microphone in a direction toward a speaker by specifying a speaking direction and a location of the speaker by using a microphone array or image recognition, in order to improve sound collecting capability or remove noise. Furthermore, for example, there is known a technology of causing an imaging unit, such as a camera, to be oriented toward a speaker and cropping video that mainly shows the speaker, in order to provide video in which the speaker can easily be recognized to a site of the other party.

However, when the imaging unit is oriented toward a speaker by using a function to track the speaker and then video of the speaker is cropped, the speaker is imaged in the center of a screen and each speaker is cropped one by one in the screen. In this case, video of a single conference site shows only the speaker, and if a conversation is held in the same site, video showing a current speaker is provided in a switching manner every time the speaker is changed. That is, as the video, a screen showing a large image of a single speaker is frequently changed, and therefore, in the site of the other party that receives only the video, it is difficult to recognize a positional relationship between the conference participants and the atmosphere of the conference held in the site.

For example, as one case of a conference, a video conference connecting a plurality of sites may be configured such that a main discussion is performed in a site (main site) in which a large number of participants are present, and a site (sub site) in which the number of speeches is relatively small is connected to the video conference. In this case, video in which speakers in the main site are switched from one another is continuously provided on a conference screen viewed in the sub site, and only a speaker is displayed in the screen, so that it is difficult to recognize the atmosphere of the conference and a positional relationship between the participants in the main site.

Therefore, a technology has been disclosed in which a certain speaker is specified, video in which the speaker is cropped and video in which an object (in this case, an explanatory material) that the speaker has looked at is cropped are extracted, and the pieces of the extracted video are transmitted as composite video to the other sites (for example, see Japanese Unexamined Patent Application Publication No. 2012-119927). In the technology disclosed in Japanese Unexamined Patent Application Publication No. 2012-119927, the atmosphere of the entire teleconference can be conveyed by the speaker and the object that the speaker has looked at, without switching a shooting range of the imaging unit.

However, in the technology disclosed in Japanese Unexamined Patent Application Publication No. 2012-119927, if a plurality of speakers are speaking (having a conversation) in a single site, it is difficult to convey the atmosphere of a conference or the like and a positional relationship between the participants in the site to the other sites.

In view of the above circumstances, there is a need to provide a communication device, a communication system, and a computer-readable recoding medium containing a computer program that, when a plurality of speakers are speaking in a single site, can convey the sense of distance between the speakers in the site and the atmosphere of the site to other sites.

### SUMMARY OF THE INVENTION

According to exemplary embodiments of the present invention, there is provided a communication device comprising: a voice input unit configured to input voice that occurs in a site in which the communication device is installed; an imaging unit configured to capture an image of an inside of the site; a recording unit configured to, when speech is made in the site, record a speech spot indicating a location of a speaker and a time in a storage unit; a range determining unit configured to, when a plurality of the speech spots in the site are recorded within a predetermined time, determine a shooting range including the recorded speech spots; and a transmitting unit configured to transmit video of the determined shooting range to other communication device installed in other site.

Exemplary embodiments of the present invention also provide a communication system comprising: a plurality of communication devices that are installed in a plurality of sites and are connected to one another via a network. In the communication system, each of the communication devices includes: a voice input unit configured to input voice that occurs in a site in which the communication device is installed; an imaging unit configured to capture an image of an inside of the site; a recording unit configured to, when speech is made in the site, record a speech spot indicating a location of a speaker and a time in a storage unit; a range determining unit configured to, when a plurality of the speech spots in the site are recorded within a predetermined time, determine a shooting range including the recorded speech spots; and a transmitting unit configured to transmit video of the determined shooting range to other communication device installed in other site.

Exemplary embodiments of the present invention also provide a non-transitory computer-readable recording medium including a computer program for causing a computer to execute: inputting voice that occurs in a site in which the computer is installed; capturing an image of an inside of the site; recording, when speech is made in the site, a speech spot indicating a location of a speaker and a time in a storage unit; determining, when a plurality of the speech spots in the site are recorded within a predetermined time, a shooting range including the recorded speech spots; and transmitting video of the determined shooting range to other communication device installed in other site.

### BRIEF DESCRIPTION OF THE DRAWINGS

FIG. 1 is a schematic configuration diagram of a teleconference system according to an embodiment of the present invention;

FIG. 2 is a diagram for explaining sites in which the teleconference system according to the embodiment is installed;

FIG. 3 is a diagram illustrating an example of a hardware configuration of a communication device according to the embodiment;

FIG. 4 is a block diagram illustrating a functional configuration example of the communication device;

FIG. 5 is a diagram for explaining video to be transmitted to other sites when a conversation is held in a site A;

FIG. 6 is a flowchart illustrating the flow of a process of transmitting video of a conference using the teleconference system according to the embodiment;

FIG. 7 is a diagram illustrating video of a shooting range;

FIG. 8 is a diagram for explaining video to be transmitted to the other sites when one of participants in the site A makes speech; and

FIG. 9 is a diagram for explaining video to be transmitted to the other sites when a conversation is held in the site A.

The accompanying drawings are intended to depict exemplary embodiments of the present invention and should not be interpreted to limit the scope thereof. Identical or similar reference numerals designate identical or similar components throughout the various drawings.

### DETAILED DESCRIPTION OF THE PREFERRED EMBODIMENTS

The terminology used herein is for the purpose of describing particular embodiments only and is not intended to be limiting of the present invention.

As used herein, the singular forms “a”, “an” and “the” are intended to include the plural forms as well, unless the context clearly indicates otherwise.

In describing preferred embodiments illustrated in the drawings, specific terminology may be employed for the sake of clarity. However, the disclosure of this patent specification is not intended to be limited to the specific terminology so selected, and it is to be understood that each specific element includes all technical equivalents that have the same function, operate in a similar manner, and achieve a similar result.

Exemplary embodiments of a communication device, a communication system, and a computer-readable recording medium having a computer program according to the present invention will be described in detail below with reference to the accompanying drawings. In the following, a teleconference system that implements a remote conference between geographically remote sites will be described as one example of the communication system to which the present invention is applied. In the teleconference system, the remote conference is implemented by causing teleconference communication devices (hereinafter, referred to as “communication devices”) installed in a plurality of sites to perform communication by using a network. However, the communication system to which the present invention is applicable is not limited to this example. The present invention is widely applicable to various communication systems that transmit and receive video between a plurality of communication devices, and various communication devices used in the communication systems.

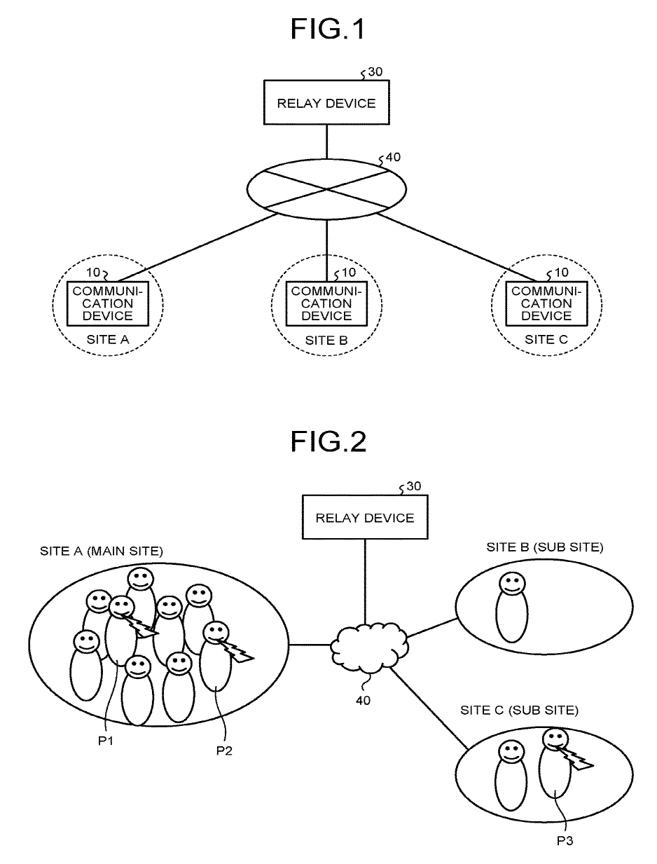

FIG. 1 is a schematic configuration diagram of a teleconference system according to an embodiment of the present invention. As illustrated in FIG. 1, the teleconference system of the embodiment includes communication devices 10 installed in a plurality of sites and a relay device 30, which are connected to one another via a network 40. For example, the network 40 is constructed by independently using one of network technologies, such as the Internet and a local area network (LAN), or by a combination of the network technologies. The network 40 may include not only wired communication, but also wireless communication using Wireless Fidelity (WiFi) or Bluetooth (registered trademark).

The number of the communication devices 10 included in the teleconference system is equal to the number of sites that participate in a conference. In the embodiment, as one example, it is assumed that a remote conference is held among three sites such as sites A to C, and the three communication devices 10 are connected to the network 40. Incidentally, registration and management of each of the communication devices 10, a process of login to the teleconference system from the communication devices 10 in the respective sites that participate in the conference, a process of establishing a session for performing communication between the communication devices 10 in the respective sites, and the like may be implemented by using a well-known technique disclosed in, for example, Japanese Unexamined Patent Application Publication No. 2014-209299, and therefore, detailed explanation thereof will be omitted.

The communication device 10 transmits and receives data to and from the communication devices 10 in the other sites, and controls output of received data. The data handled herein includes video of each of the sites captured by a camera, voice in each of the sites collected by a microphone, and the like. Video data and voice data are transferred between the communication devices 10 via the relay device 30. Incidentally, the communication device 10 may be a special terminal dedicated to the teleconference system, or may be a general-purpose terminal, such as a personal computer (PC), a smartphone, or a tablet terminal. When a device program (to be described later) is installed in a general-purpose terminal, the general-purpose terminal implements functions of the communication device 10 as one application.

FIG. 2 is a diagram for explaining the sites in which the teleconference system according to the embodiment is installed. As illustrated in FIG. 2, it is assumed that a conference described in the embodiment is configured such that a large number of participants are present in the site A that is a main site, and a few participants are present in each of the site B and the site C that are sub sites. In the site A, for example, a chairman who leads the conference is present and discussions are performed. Furthermore, it is assumed that speech is made in each of the sites B and C, but the duration of the speech is relatively short in terms of the percentage of the total duration. FIG. 2 illustrates a situation in which two participants P1 and P2 in the site A and a participant P3 in the site C are making speech.

Referring back to FIG. 1, the relay device 30 is a server computer that relays transfer of video data and voice data between the communication devices 10 in the respective sites. In the embodiment, it is assumed that the video data transmitted by the communication device 10 in each of the sites is coded in a scalable coding format, such as the H.264/SVC format. The relay device 30 has a function to convert video data, which is coded in a scalable manner and transmitted by the communication device 10 serving as a transmission source, into data of certain quality requested by the communication device 10 on the receiving side, and to transfer the converted data to the communication device 10 on the receiving side, in accordance with a reception request (to be described later) transmitted from the communication device 10 on the receiving side.

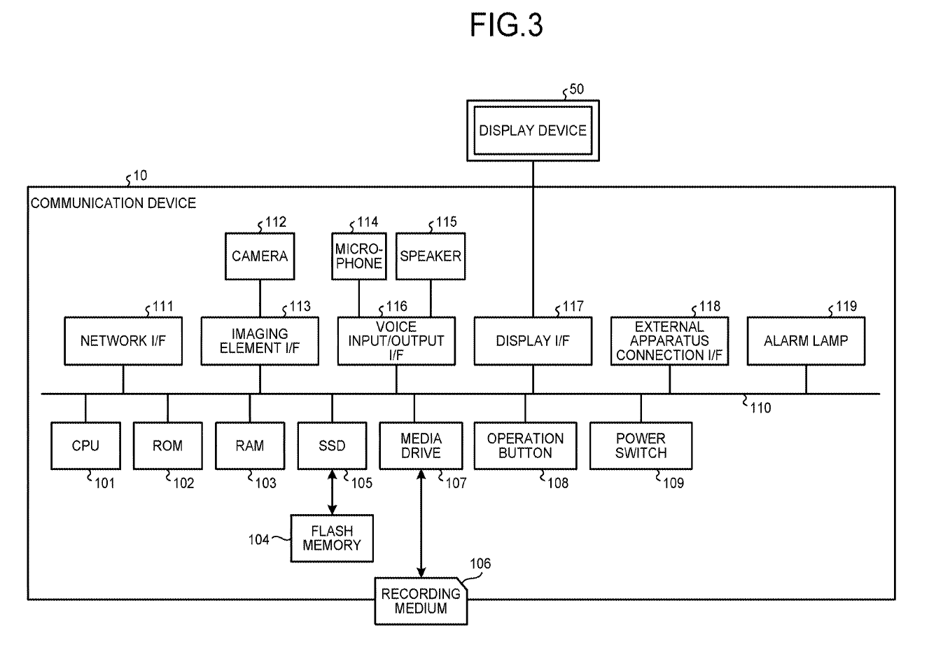

Next, a hardware configuration of the communication device 10 in the teleconference system of the embodiment will be described. FIG. 3 is a diagram illustrating an example of the hardware configuration of the communication device according to the embodiment.

As illustrated in FIG. 3, the communication device 10 includes a central processing unit (CPU) 101 that controls the entire operation of the communication device 10, a read only memory (ROM) 102 that stores therein a program, such as an initial program loader (IPL), used to drive the CPU 101, and a random access memory (RAM) 103 used as a work area of the CPU 101.

Furthermore, the communication device 10 includes a flash memory 104 that stores therein a terminal program and various kinds of data, such as image data or voice data, a solid state drive (SSD) 105 that controls read and write of various kinds of data with respect to the flash memory 104 under the control of the CPU 101, and a media drive 107 that controls read and write (storage) of data with respect to a recording medium 106.

Moreover, the communication device 10 includes an operation button 108 that is operated to select the other communication device 10 that serves as the other party of communication, a power switch 109 for switching ON and OFF of a power supply of the communication device 10, and a network interface (I/F) 111 for transferring data by using the network 40.

Furthermore, the communication device 10 includes a built-in camera 112 that captures an image of an object and obtains image data under the control of the CPU 101, and an imaging element I/F 113 that controls drive of the camera 112. Moreover, the communication device 10 includes a built-in microphone 114 for inputting voice, a built-in speaker 115 for outputting voice, and a voice input/output I/F 116 that performs a process of inputting and outputting a voice signal between the microphone 114 and the speaker 115 under the control of the CPU 101.

Furthermore, the communication device 10 includes a display I/F 117 for transferring data of video to be displayed on a display device 50 under the control of the CPU 101, an external apparatus connection I/F 118 for connecting various external apparatuses, and an alarm lamp 119 that indicates abnormality of various functions of the communication device 10. Moreover, the communication device 10 includes a bus line 110, such as an address bus or a data bus, for electrically connecting the above-described components.

It is assumed that the display device 50 is a projection device, such as a liquid crystal panel or a projector, that is externally attached to the communication device 10. However, the display device 50 may be incorporated in the communication device 10. Incidentally, the hardware configuration of the communication device 10 illustrated in FIG. 3 is one example, and it may be possible to add hardware other than those described above.

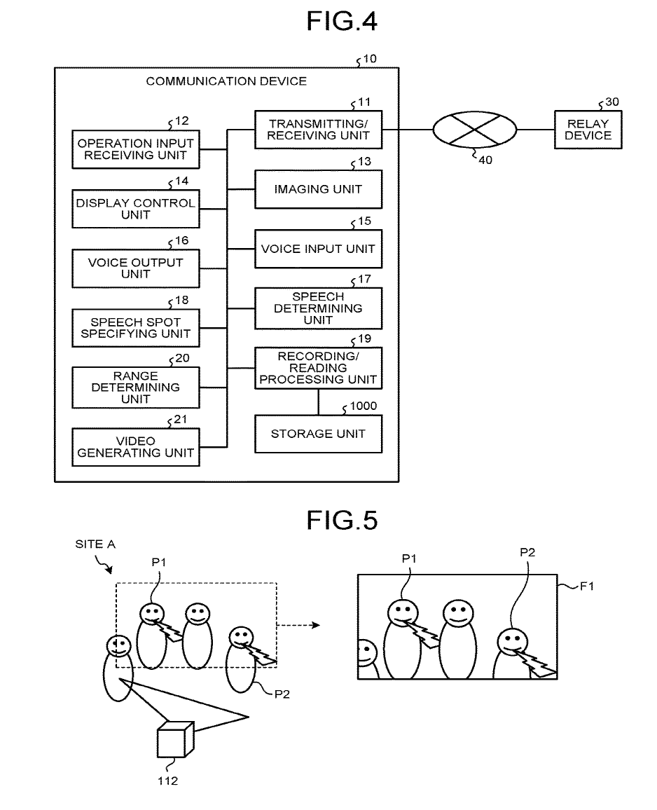

Next, a functional configuration of the communication device 10 will be described. FIG. 4 is a block diagram illustrating a functional configuration example of the communication device. As illustrated in FIG. 4, the communication device 10 includes a transmitting/receiving unit 11, an operation input receiving unit 12, an imaging unit 13, a display control unit 14, a voice input unit 15, a voice output unit 16, a speech determining unit 17, a speech spot specifying unit 18, a recording/reading processing unit 19, a range determining unit 20, and a video generating unit 21.

These units are functions implemented by, for example, causing the CPU 101 to execute the device program that is loaded on the RAM 103 from the flash memory 104 illustrated in FIG. 3. Furthermore, the communication device 10 includes a storage unit 1000 configured with, for example, the RAM 103 and the flash memory 104 illustrated in FIG. 3.

The storage unit 1000 stores therein, for example, specific information, such as identification information or an IP address, assigned to the communication device 10, information needed to perform communication with the other communication devices 10, or the like. Furthermore, the storage unit 1000 is also used as a reception buffer for temporarily storing video data and voice data that are transmitted from the communication devices 10 in the other sites via the relay device 30. Moreover, a speech spot indicating a location of a speaker when speech is made in the site, and a time at which the speech is made are recorded in the storage unit 1000.

The transmitting/receiving unit 11 transmits and receives various kinds of data to and from the communication devices 10 in the other sites via the relay device 30 over the network 40. The transmitting/receiving unit 11 is implemented by, for example, the network I/F 111 and the CPU 101 illustrated in FIG. 3. In the embodiment, the transmitting/receiving unit 11 transmits video of a shooting range determined by the range determining unit 20 and voice input to the voice input unit 15 to the other communication devices 10 in the other sites via the relay device 30. Furthermore, the transmitting/receiving unit 11 functions as a transmitting unit.

Incidentally, video of the shooting range is, for example, video obtained by the video generating unit 21 by cropping the shooting range from video in which the inside of the site is captured, or video of the shooting range inside the site captured by the imaging unit 13.

The operation input receiving unit 12 receives input of various operations from a user using the communication device 10. The operation input receiving unit 12 is implemented by, for example, the operation button 108, the power switch 109, and the CPU 101 illustrated in FIG. 3.

The imaging unit 13 captures video inside the site in which the communication device 10 is installed. Furthermore, the imaging unit 13 captures an image of the shooting range inside the site, where the shooting range is determined by the range determining unit 20. The video captured by the imaging unit 13 is coded in a scalable coding format, such as the H.264/SVC format, and is transmitted from the transmitting/receiving unit 11 to the relay device 30.

Incidentally, the format of the video data is not limited to H.264/SVC, and other formats, such as H.264/AVC, H.265, or Web Real-Time Communication (WebRTC), may be used. The imaging unit 13 is implemented by, for example, the camera 112, the imaging element I/F 113, and the CPU 101 illustrated in FIG. 3.

The display control unit 14 performs a drawing process or the like by using video of the other site, which is received by the transmitting/receiving unit 11 and decoded, and then sends the processed data to the display device 50 to thereby display a screen including the video of the other site on the display device 50. The display control unit 14 is implemented by, for example, the display I/F 117 and the CPU 101 illustrated in FIG. 3.

The voice input unit 15 inputs voice inside the site in which the communication device 10 is installed. The voice input to the voice input unit 15 is coded in an arbitrary coding format, such as pulse code modulation (PCM), and then transmitted from the transmitting/receiving unit 11 to the relay device 30. The voice input unit 15 is implemented by, for example, the microphone 114, the voice input/output I/F 116, and the CPU 101 illustrated in FIG. 3.

The voice output unit 16 reproduces and outputs the voice of the other site, which is received by the transmitting/receiving unit 11 and decoded. The voice output unit 16 is implemented by, for example, the speaker 115, the voice input/output I/F 116, and the CPU 101 illustrated in FIG. 3.

The speech determining unit 17 determines whether speech is made in the site in which the communication device 10 is installed, from the voice input to the voice input unit 15 or the video captured by the imaging unit 13. Specifically, the speech determining unit 17 specifies a speaker by, for example, sound detection using a microphone array or the like. Incidentally, steady noise or non-steady noise, such as unexpected sound, is not determined as voice. Furthermore, the speech determining unit 17 specifies a speaker by performing, for example, image recognition on the video captured by the imaging unit 13. In the embodiment below, an example will be described in which whether speech is made is determined based on voice; however, the same applies to a case in which whether speech is made is determined based on video.

When the speech determining unit 17 determines that speech is made in the site in which the communication device 10 is installed, the speech spot specifying unit 18 specifies a speech spot indicating a location of a speaker who has made the speech. Specifically, the speech spot specifying unit 18 detects a speech direction with respect to the voice input to the voice input unit 15. For example, if a technology using a microphone array is employed, a direction in which the voice has occurred and a distance to a spot at which the voice has occurred are detected based on a temporal difference input to a plurality of microphones by using the microphones.

The recording/reading processing unit 19 performs a process of storing (recording) and reading various kinds of data to and from the storage unit 1000. Furthermore, the recording/reading processing unit 19 of the embodiment records the speech spot (a location of a speaker) in the storage unit 1000 together with a time. The recording/reading processing unit 19 is implemented by, for example, the SSD 105 and the CPU 101 illustrated in FIG. 3. The recording/reading processing unit 19 functions as a recording unit.

If a plurality of speech spots in the site in which the communication device 10 is installed are registered in the storage unit 1000 within a predetermined time set in advance, the range determining unit 20 determines, as the shooting range, a range including the recorded speech spots, that is, a range including a plurality of conference participants who are making speech.

In the embodiment, for example, if speech is made in the site in which the communication device 10 is installed, and if previous speech is also made in the same site, the range determining unit 20 determines whether a speech interval between a recorded time of the current speech and a recorded time of the previous speech is within the predetermined time set in advance. Then, if the speech interval is within the predetermined time, the range determining unit 20 determines that the previous speech and the current speech are part of a conversation, and determines a range including a previous speech spot and a current speech spot as the shooting range.

When the range determining unit 20 determines the shooting range, the video generating unit 21 generates video to be transmitted to the other sites by cropping video of the determined shooting range from the video of the inside of the site captured by the imaging unit 13. Then, the video of the shooting range, which is generated by cropping, is transmitted to the other sites by the transmitting/receiving unit 11.

FIG. 5 is a diagram for explaining video to be transmitted to the other sites when a conversation is held in the site A. FIG. 5 illustrates a state in which the conference participants P1 and P2 in the site A are making speech. If the speech of the participant P1 and the speech of the participant P2 are made within the predetermined time, it is determined that the speech is part of a conversation, and video F1 of a shooting range including both of the participants P1 and P2 is cropped from the video of the site A captured by the camera 112. Then, the cropped video F1 is transmitted to the other sites. Consequently, it becomes possible to convey, to the other sites, a positional relationship and the atmosphere of the participants having a conversation during the conference.

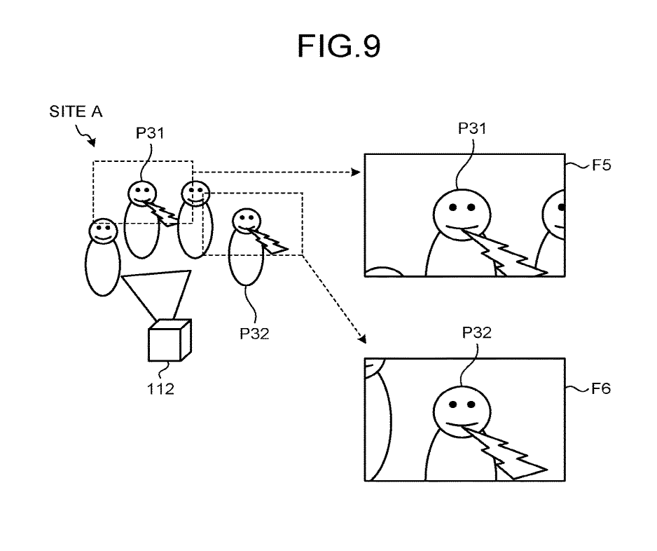

A conventional teleconference system will be described below. FIG. 8 is a diagram for explaining video to be transmitted to the other sites when one of the participants in the site A makes speech. FIG. 9 is a diagram for explaining video F4 to be transmitted to the other sites when a conversation is held in the site A.

In FIG. 8, for example, a conference participant P21 in the site A is making speech. In this case, in the conventional teleconference system, the camera 112 captures an image by being oriented such that the mouth of the participant P21 corresponding to a voice generated spot appears in the center of a screen.

Furthermore, in FIG. 9, for example, conference participants P31 and P32 in the site A are having a conversation. In this case, in the conventional teleconference system, video F5 and video F6 each mainly showing a speaker of each speech are provided in a switching manner in the other sites. That is, if the participant P31 makes speech, the video F5 mainly showing the participant P31 is generated, and if the participant P32 subsequently makes speech, the video F6 mainly showing the participant P32 is generated. Then, the generated video F5 and the generated video F6 are transmitted to the other sites and displayed in a switching manner.

Therefore, conference participants viewing the video of the site A in the other sites may have impression that each individual is separately making speech rather than they are having a conversation in the site A. That is, in the other sites, it is difficult to recognize a positional relationship between the conference participants and the atmosphere of the conference being held in the site A through the video.

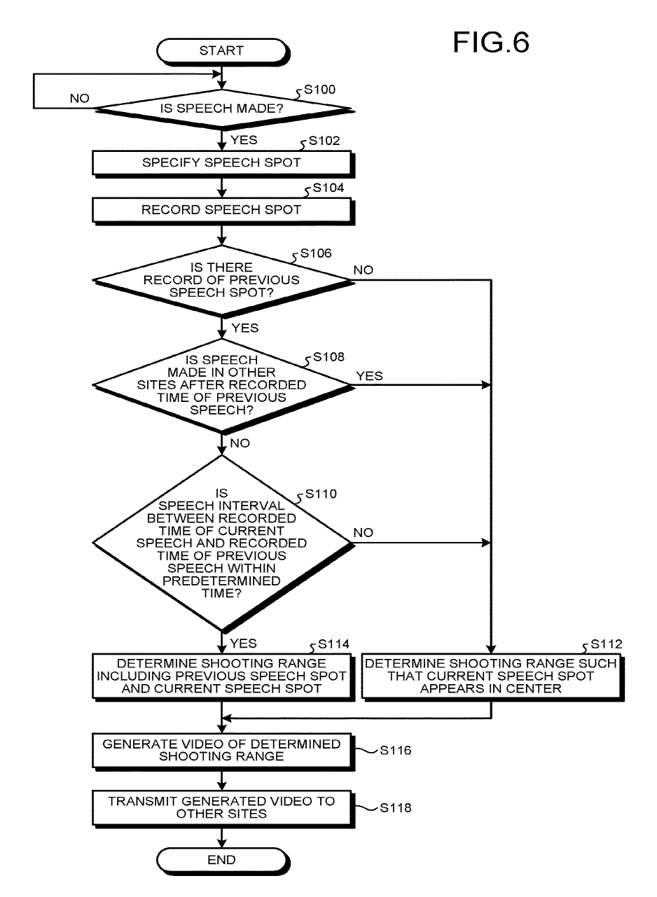

Next, a process of transmitting video of a conference using the teleconference system of the embodiment will be described. FIG. 6 is a flowchart illustrating the flow of the process of transmitting video of a conference using the teleconference system according to the embodiment. FIG. 6 illustrates a process of transmitting video from the site A that is the main site when a conference is performed among the sites A to C as illustrated in FIG. 2.

Incidentally, in FIG. 6, as one example, it is assumed that whether speech is made is specified by sound detection using a microphone array or the like, and then the speech spot is specified. However, it is possible to specify a speaker by performing image recognition on a captured image. Furthermore, as for the video of the shooting range, it is assumed that the video of the determined shooting range is obtained by moving the imaging unit itself, such as a camera, by using a pan-tilt-zoom function. However, it may be possible to crop the determined shooting range from the video in which the entire site is extensively captured.

First, the speech determining unit 17 determines whether speech is made in the site A by determining whether voice is input from the microphone 114 to the voice input unit 15 (Step S100). If speech is not made in the site A (NO at Step S100), the process is returned and repeated.

In contrast, if speech is made in the site A (YES at Step S100), the speech spot specifying unit 18 specifies a speech spot (Step S102). Then, the recording/reading processing unit 19 records the specified speech spot and a time in the storage unit 1000 (Step S104).

Incidentally, it is assumed that a plurality of speech spots are recorded in accordance with time divisions. In FIG. 6, a case will be described in which two kinds of speech such as current speech and previous speech are made. Incidentally, it may be possible to further record past speech spots and transmit pieces of video in accordance with the plurality of the speech spots. The data to be recorded includes the speech spot that is a location where the speech is made, and a speech time.

Subsequently, the range determining unit 20 determines whether a record of a previous speech spot is recorded in the storage unit 1000 (Step S106). If the record of the previous speech spot is not recorded (NO at Step S106), it is determined that a conversation is not held in the site A, and a shooting range is determined such that the current speech spot appears in the center (Step S112).

In contrast, if the record of the previous speech spot is recorded (YES at Step S106), the range determining unit 20 determines whether speech is made in the other sites after the recorded time of the previous speech (Step S108). That is, in this process, it is determined whether the record of the previous speech is present and whether a conversation with the other site is held after the recorded time of the previous speech.

If speech is made in the other site (YES at Step S108), it is determined that a conversation is not held in the site A, and a shooting range is determined such that the current speech spot appears in the center (Step S112). In contrast, if speech is not made in the other site (NO at Step S108), the range determining unit 20 determines whether a speech interval between the recorded time of the current speech and the recorded time of the previous speech is within a predetermined time (Step S110).

If the speech interval is not within the predetermined time (NO at Step S110), it is determined that a conversation is not held in the site A, and a shooting range is determined such that the current speech spot appears in the center (Step S112).

In contrast, if the speech interval is within the predetermined time (YES at Step S110), it is determined that a conversation is held in the site A, and a shooting range including the previous speech spot and the current speech spot is determined (Step S114). That is, in this process, if a conversation with the other site is not held after the recorded time of the previous speech and if a time from the recorded time of the previous speech to the recorded time of the current speech is short, it is determined that a conversation is held in the site A.

Then, the video generating unit 21 generates video of the determined shooting range (Step S116), and the transmitting/receiving unit 11 transmits the generated video to the other communication devices in the other sites (Step S118).

As described above, in FIG. 6, if a plurality of speakers have a conversation within a predetermined time in the site A that is a single site, a plurality of voice generated spots are handled as a group, and a shooting range is determined such that the entire voice group appears, instead of showing a voice generated spot in the center of the video. Then, by cropping video of the determined shooting range or capturing an image of the determined shooting range, it is possible to more clearly convey the sense of distance between the speakers and the atmosphere of the site to the other sites. Therefore, when the latest voice generated spot is specified, as a method of tracking a speaker, a plurality of the voice generated spots are recorded for a certain period of time and a plurality of the voice generated spots in a single site are specified, instead of causing an imaging unit to be oriented toward the voice generated spot or cropping video of the voice generated spot as in the conventional technology. Then, if the voice generated spots are specified, it is possible to determine that a conversation is held, cause the imaging unit and the video cropping unit to generate video for transmitting a shooting range including the plurality of the voice generated spots, and transmit the generated video to the other sites.

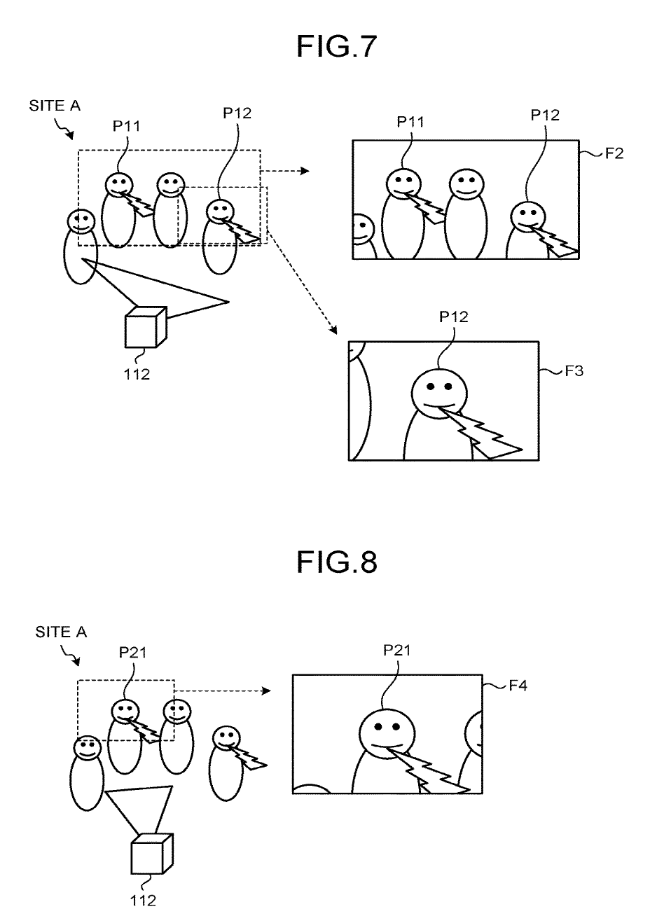

The video of the shooting range determined in FIG. 6 will be described below. FIG. 7 is a diagram illustrating the video of the shooting range. As illustrated in FIG. 7, a plurality of conference participants are present in the site A, and the camera 112 captures an image of the site A. Furthermore, the participants P11 and P12 are making speech in the site A.

At Step S114 in FIG. 6, it is determined that a conversation is held in the site A. Therefore, as illustrated in FIG. 7, a shooting range is set so as to obtain video F2 in which the plurality of the speakers P11 and P12 are captured.

In contrast, at Step S112 in FIG. 6, it is determined that a conversation is not held in the site A. Therefore, as illustrated in FIG. 7, a shooting range is set so as to obtain video F3 in which only the participant P12 is captured.

As described above, when a conference or the like is performed by communication devices installed in a plurality of sites, the teleconference system of the embodiment determines that a conversation is held when a plurality of participants have made speech in a single site within a predetermined time set in advance, and transmits video of a shooting range including the plurality of the participants (speakers) to the other sites. Therefore, when a plurality of speakers are speaking in a single site, it is possible to more clearly convey the sense of distance between the speakers in the site and the atmosphere of the site to the other sites.

The above-described device program is stored in, for example, the flash memory 104, and loaded and executed on the RAM 103 under the control of the CPU 101. The memory for storing the device program is not limited to the flash memory 104 as long as the memory is a nonvolatile memory. For example, an electrically erasable and programmable ROM (EEPROM) or the like may be used as the memory. Furthermore, the device program may be provided by being recorded in the recording medium 106, which is a non-transitory computer-readable recording medium, in a computer-installable or computer-executable file. Moreover, the device program may be provided as an incorporated program stored in the ROM 102 in advance.

Furthermore, the device program executed by the communication device of the embodiment may be stored in a computer connected to a network, such as the Internet, and may be provided by being downloaded via the network. Moreover, the device program executed by the communication device of the embodiment may be provided or distributed via a network, such as the Internet.

Furthermore, the device program executed by the communication device of the embodiment has a module structure including the above-described units (the transmitting/receiving unit 11, the operation input receiving unit 12, the imaging unit 13, the display control unit 14, the voice input unit 15, the voice output unit 16, the speech determining unit 17, the speech spot specifying unit 18, the recording/reading processing unit 19, the range determining unit 20, and the video generating unit 21). As actual hardware, a CPU (processor) reads the device program from the above-described storage medium and executes the device program so that the above-described units are loaded on a main storage device and generated on the main storage device. Furthermore, for example, part or all of the functions of the above-described units may be implemented by a special hardware circuit.

According to exemplary embodiments of the present invention, when a plurality of speakers are speaking in a single site, it is possible to more clearly convey the sense of distance between the speakers in the site and the atmosphere of the site to the other sites.

The above-described embodiments are illustrative and do not limit the present invention. Thus, numerous additional modifications and variations are possible in light of the above teachings. For example, at least one element of different illustrative and exemplary embodiments herein may be combined with each other or substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

Further, any of the above-described apparatus, devices or units can be implemented as a hardware apparatus, such as a special-purpose circuit or device, or as a hardware/software combination, such as a processor executing a software program.

Further, as described above, any one of the above-described and other methods of the present invention may be embodied in the form of a computer program stored in any kind of storage medium. Examples of storage mediums include, but are not limited to, flexible disk, hard disk, optical discs, magneto-optical discs, magnetic tapes, nonvolatile memory, semiconductor memory, read-only-memory (ROM), etc.

Alternatively, any one of the above-described and other methods of the present invention may be implemented by an application specific integrated circuit (ASIC), a digital signal processor (DSP) or a field programmable gate array (FPGA), prepared by interconnecting an appropriate network of conventional component circuits or by a combination thereof with one or more conventional general purpose microprocessors or signal processors programmed accordingly.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA) and conventional circuit components arranged to perform the recited functions.

What is claimed is:

1. A communication device comprising:
a voice input unit configured to input voice that occurs in a site in which the communication device is installed;
an imaging unit configured to capture an image of an inside of the site;
a recording unit configured to, when speech is made in the site, record a speech spot indicating a location of a speaker and a time in a storage unit;
a range determining unit configured to, when a plurality of the speech spots in the site are recorded within a predetermined time, determine a shooting range including the recorded speech spots; and
a transmitting unit configured to transmit video of the determined shooting range to other communication device installed in other site.

2. The communication device according to claim 1, wherein
the range determining unit determines whether a speech interval between a recorded time of current speech and recorded time of previous speech is within the predetermined time, and determines the shooting range including a previous speech spot and a current speech spot when the speech interval is within the predetermined time.

3. The communication device according to claim 1, further comprising:
a video generating unit configured to crop video of the determined shooting range from video captured by the imaging unit, wherein
the transmitting unit transmits the cropped video of the shooting range to the other communication device.

4. The communication device according to claim 1, wherein
the imaging unit captures an image of the determined shooting range, and
the transmitting unit transmits video of the captured shooting range to the other communication device.

5. A communication system comprising:
a plurality of communication devices that are installed in a plurality of sites and are connected to one another via a network, wherein
each of the communication devices includes:
a voice input unit configured to input voice that occurs in a site in which the communication device is installed;
an imaging unit configured to capture an image of an inside of the site;
a recording unit configured to, when speech is made in the site, record a speech spot indicating a location of a speaker and a time in a storage unit;
a range determining unit configured to, when a plurality of the speech spots in the site are recorded within a predetermined time, determine a shooting range including the recorded speech spots; and
a transmitting unit configured to transmit video of the determined shooting range to other communication device installed in other site.

6. A non-transitory computer-readable recording medium including a computer program for causing a computer to execute:
inputting voice that occurs in a site in which the computer is installed;
capturing an image of an inside of the site;
recording, when speech is made in the site, a speech spot indicating a location of a speaker and a time in a storage unit;
determining, when a plurality of the speech spots in the site are recorded within a predetermined time, a shooting range including the recorded speech spots; and
transmitting video of the determined shooting range to other communication device installed in other site.
